(19) United States
(12) Patent Application Publication
(10) Pub. No.: US 2008/0265024 A1
(43) Pub. Date: Oct. 30, 2008

(54) Electronic device with functional module

(76) Inventors: Mark S. Tracy, Tomball, TX (US); Paul J. Doczy, Cypress, TX (US); Jonathan R. Harris, Cypress, TX (US); Earl W. Moore, Cypress, TX (US); L. Joy Griebenow, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/799,256

(22) Filed: Apr. 30, 2007

(51) Int. Cl. G06K 5/00

(52) U.S. Cl. 235/382

(57) ABSTRACT

A electronic device comprises a housing having a module bay configured to receive insertion of a modular biometric reader therein, the modular biometric reader located and usable within a periphery of the housing when disposed in the module bay.

### BACKGROUND

Many features of electronic devices are configured as optional features such that, if a particular user or customer desires to have a particular feature on the electronic device, the electronic device is manufactured containing the desired optional feature. For example, computing devices, such as notebook or tablet computers, may be configured with or without a camera or webcam module, with or without particular wireless capabilities, and/or with or without a particular security feature, such as a locking device or a fingerprint reader. However, optional features that are generally integrated into the electronic device, such as integrated into a housing or bezel of the electronic device, generally require that particular parts be specially manufactured to accommodate such optional features, thereby resulting in increased costs associated with manufacturing and tracking these extra components, as well as the increased cost associated with disassembling and/or interchanging of these parts to accommodate a particular desired optional feature.

### BRIEF DESCRIPTION OF THE DRAWINGS

FIGS. 1A and 1B are diagrams illustrating an embodiment of an electronic device with a functional module.

### DETAILED DESCRIPTION OF THE DRAWINGS

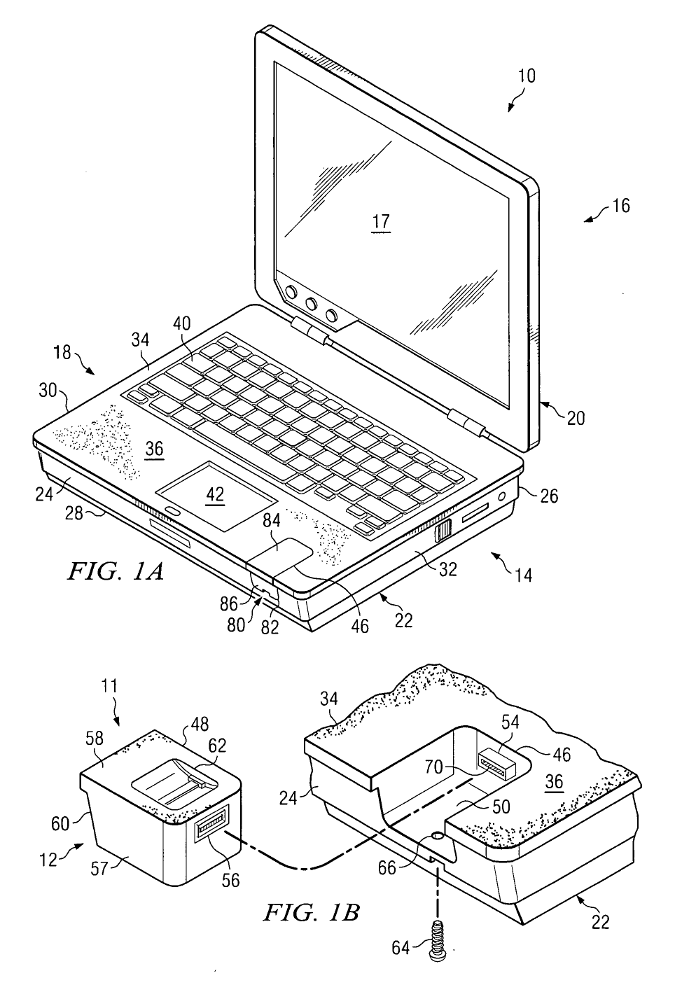

FIGS. 1A and 1B are diagrams illustrating an embodiment of an electronic device 10 having a functional modular unit 11 in the form of a modular biometric reader 12. In the embodiment illustrated in FIGS. 1A and 1B, electronic device 10 comprises a notebook computer 14 having a display member 16 with a display screen 17 rotatably coupled to a base member 18. However, it should be understood that electronic device 10 may comprise other types of devices and/or computing systems such as, but not limited to, a tablet computer, a personal digital assistant (PDA), a gaming device, a media player and a portable telephone. It should be understood that functional modular unit 11 may comprise other types of devices instead of a biometric unit such as, but not limited to, a speaker, a voice transceiver, a wireless earphone or other type of hearing apparatus, a pointing device (e.g., a laser pointer), etc. In the description below, electronic device 10 and functional modular unit 11 are described in connection with modular biometric reader 12; however, it should be understood that other types of functional modular units 11 may be substituted for modular biometric reader 12 in the description below (e.g., a speaker, a voice transceiver, a wireless earphone or other type of hearing apparatus, a pointing device (e.g., a laser pointer), etc.). In some embodiments, functional modular unit(s) 11 is operational when embedded or coupled to electronic device 10; however, it should also be understood that functional modular unit(s) 11 may be operational when detached and/or separated from electronic device 10.

In the embodiment illustrated in FIGS. 1A and 1B, display member 16 and base member 18 each comprise a housing 20 and 22, respectively, formed of a number of walls for supporting and/or otherwise enclosing various components of electronic device 10. For example, in FIGS. 1A and 1B, housing 22 comprises a front wall 24, a rear wall 26, a bottom wall 28, a pair of side walls 30 and 32, and a top wall 34 defining a working surface 36 of electronic device 10. Working surface 36 generally comprises one or more functional elements used by a user of electronic device 10 in order to interact with electronic device 10. For example, in FIGS. 1A and 1B, working surface 36 comprises a keyboard 40 and a touchpad 42. However, it should be understood that different and/or additional functional components of electronic device 10 may be disposed on working surface 36.

In the embodiment illustrated in FIGS. 1A and 1B, housing 22 comprises a module bay 46 for receiving modular biometric reader 12. Referring to FIG. 1B, modular biometric reader 12 comprises a fingerprint reader 48; however, it should be understood that other types of biometric reading devices may be used. In FIGS. 1A and 1B, module bay 46 is configured to be accessible from an exterior area of electronic device 10 to facilitate ready insertion of modular biometric reader 12 into module bay 46. For example, in the embodiment illustrated in FIGS. 1A and 1B, module bay 46 comprises a cavity 50 that is open toward and/or otherwise accessible from an exterior of electronic device 10. In FIGS. 1A and 1B, cavity 50 is open toward and/or otherwise accessible from at least a portion of working surface 36 via top wall 34 and at least a portion of front wall 24. However, it should be understood that module bay 46 may be otherwise configured and/or located. For example, in FIGS. 1A and 1B, module bay 46 is located in base member 18 in a palm rest area 38 of electronic device 10 (e.g., a location of working surface 36 generally in contact with and/or located proximate to the palms of a user when the user is utilizing keyboard 40 of electronic device 10). However, it should be understood that module bay 46 may be otherwise located (e.g., additionally or alternatively, in display member 16). In FIGS. 1A and 1B, one module bay 46 is illustrated; however, it should be understood that multiple module bays 46 may be located on electronic device 10 to facilitate a greater number of modular units 11 and/or different types of modular units 11.

Referring to FIG. 1B, a connector 54 is disposed within module bay 46 for communicatively engaging a corresponding connector 56 disposed on modular biometric reader 12. In some embodiments, modular biometric reader 12 is configured to be operable via power supplied by electronic device 10 via connector 54. However, it should be understood that in some embodiments, modular biometric reader 12 is usable outside of module bay 46 via power supplied by an on-board power source of modular biometric reader 12 and/or through a cable or other element coupling modular biometric reader 12 to electronic device 10 (e.g., usable separate and apart from module bay 46). Modular biometric reader 12 may also be configured to communicate wirelessly with electronic device 10.

Further, in some embodiments, modular biometric reader 12 is configured to be inserted into module bay 46 and secured therein such that modular biometric reader 12, when disposed within module bay 46, is located within and usable while within a periphery of housing 22. For example, in some embodiments, modular biometric reader 12 comprises a housing 57 configured such that, when modular biometric reader 12 is disposed in module bay 46, an upper surface 58 of modular biometric reader 12 is located flush (flush or substantially flush) with working surface 36, and a front surface 60 of modular biometric reader 12 is located flush (flush or substantially flush) with front wall 24 of housing 22. Thus, in some embodiments, modular biometric reader 12 is insertable into module bay 46 such that a user interface 62 of modular biometric reader 12 (e.g., the fingerprint swipe/scan window of a fingerprint biometric reader) is located and usable while disposed within a periphery of housing 22 and, in the embodiment illustrated in FIGS. 1A and 2A, is locatable on working surface 36 of housing 22.

Additionally, in some embodiments, modular biometric reader 12 and module bay 46 are configured such that modular biometric reader 12 is insertable into and removable from module bay 46 from at least two different directions. For example, in some embodiments, modular biometric reader 12 and module bay 46 are configured such that modular biometric reader 12 is insertable into and removable from module bay 46 through front wall 24, thereby enabling modular biometric reader 12 to be insertable into and removable from module bay 46 while display member 16 is in a closed and/or tablet position relative to base member 18 (e.g., when display member 16 is located in contact with and/or adjacent to working surface 36 regardless of the direction display screen 17 is facing). In some embodiments, modular biometric reader 12 and module bay 46 are configured such that modular biometric reader 12 is insertable into and removable from module bay 46 from top wall 34 and/or working surface 36. Thus, modular biometric reader 12 may be inserted into and/or removed from electronic device 10 from a number of different directions.

In FIG. 1B, modular biometric reader 12 is securable within modular bay 46 via a fastener 64 inserted upwardly through an opening 66 in housing 22 and into modular biometric reader 12. However, it should be understood that modular biometric reader 12 may be otherwise secured within module bay 46. For example, in some embodiments, modular biometric reader 12 and/or module bay 46 may be configured such that modular biometric reader 12 is not readily removable from modular bay 46 (e.g., via a snap-fit locking mechanism that would generally prevent disengagement of modular biometric reader 12 from electronic device 10 unless performed by an authorized person and/or otherwise requiring significant disassembly of electronic device 10). Additionally, in some embodiments, connector 54 may be configured having a sensor element 70 configured to detect and/or otherwise signal a disengagement of modular biometric reader 12 from electronic device 10. For example, in some embodiments, electronic device 10 may be configured such that, in response to detecting a disengagement of modular biometric reader 12 from connector 54, an alert is generated and/or one or more functional aspects of electronic device 10 are rendered inaccessible and/or inoperable.

Embodiments of electronic device 10 facilitate ready manufacture thereof with or without modular biometric reader 12. For example, referring to FIG. 1A, module bay 46 is configured to receive a bezel module 80 therein instead of and/or in the absence of modular biometric reader 12. For example, in some embodiments, bezel module 80 is configured having a housing 82 configured similar to housing 57 of modular biometric reader 12 (FIG. 1B) such that bezel module 80 is insertable within module bay 46 to fill module bay 46 while providing a smooth and/or substantially seamless appearance of electronic device 10 (i.e., bezel module 80 being interchangeable with biometric module 12). For example, referring to FIG. 1A, bezel module 80 is configured having a top surface 84 and a front surface 86 configured to be disposed flush (flush or substantially flush) with working surface 36 and front wall 24, respectively, when bezel module 80 is located and/or otherwise secured within module bay 46. Further, as illustrated in FIG. 1A, when bezel module 80 is secured within module bay 46, bezel module 80 is located within a periphery of housing 22.

Thus, embodiments of electronic device 10 enable a biometric reader to be easily added and/or otherwise installed in electronic device 10 without necessitating extensive rework and/or disassembly of electronic device 10. For example, as illustrated in FIGS. 1A and 1B, in some embodiments, housing 22 of electronic device 10 is configured having module bay 46 that is configured to receive one of either bezel module 80 or modular biometric reader 12 therein. In some embodiments, module bay 46 is also located to enable modular biometric reader 12 to be inserted therein such that biometric reader 12 is located within a periphery of housing 22 of electronic device 10 and also such that the user interface 62 of biometric reader 12 is usable while remaining within a periphery of housing 22. Further, embodiments of electronic device 10 enable different types of functional modular units 11 to be easily replaced and/or interchanged relative to electronic device to provide a function desired by a user of electronic device 10. For example, in some embodiments, if a user desires to have a pointing device (e.g., a laser pointer) available for a presentation, the user may remove, for example, biometric reader 12 from module bay 46 and replace biometric reader 12 with a pointing device functional modular unit 11. Similarly, if a user no longer has a need for biometric reader 12 or does not want to use biometric reader 12, the user may replace biometric reader 12 with another type of functional modular unit 11, such as one or more speakers. Thus, embodiments of electronic device 10 and/or functional modular units 11 enable a variety of different types of functional modular units 11 to be readily interchanged with one another to provide a function desired by the user.

What is claimed is:

1. A electronic device, comprising:
a housing having a module bay configured to receive insertion of a modular biometric reader therein, the modular biometric reader located and usable within a periphery of the housing when disposed in the module bay.

2. The electronic device of claim 1, wherein the modular biometric reader comprises a fingerprint reader.

3. The electronic device of claim 1, wherein the module bay comprises at least one connector for communicatively engaging the modular biometric reader.

4. The electronic device of claim 1, wherein the modular biometric reader is configured to operate based on power provided by the electronic device.

5. The electronic device of claim 1, wherein the module bay is configured to receive a bezel module in an absence of the modular biometric reader.

6. The electronic device of claim 1, wherein the housing is rotatably coupled to a display member housing.

7. The electronic device of claim 1, wherein the module bay is located in a palm rest area of the electronic device.

8. The electronic device of claim 1, further comprising a sensor configured to indicate removal of the modular biometric reader from the module bay.

9. The electronic device of claim 1, wherein the module bay extends to at least two walls of the housing.

10. A electronic device, comprising:
a housing having a module bay disposed on a working surface of the electronic device and configured to receive insertion of a modular biometric reader therein.

11. The electronic device of claim 10, wherein the modular biometric reader comprises a fingerprint reader.

12. The electronic device of claim 10, wherein the module bay comprises at least one connector for communicatively engaging the modular biometric reader.

13. The electronic device of claim 10, wherein the biometric reader is configured to operate based on power provided by the electronic device.

14. The electronic device of claim 10, wherein the module bay is configured to receive a bezel module in an absence of the modular biometric reader.

15. The electronic device of claim 10, wherein the housing is rotatably coupled to a display member housing.

16. The electronic device of claim 10, wherein the module bay is located in a palm rest area of the electronic device.

17. The electronic device of claim 10, further comprising a sensor configured to indicate removal of the modular biometric reader from the module bay.

18. The electronic device of claim 10, wherein the module bay comprises a cavity extending to at least two walls of the housing.

19. A electronic device, comprising:
a housing having a cavity for receiving a modular biometric reader insertable therein, the cavity disposed on a palm rest area of the electronic device adjacent a keyboard of the electronic device.

20. The electronic device of claim 19, wherein the cavity is configured to receive a bezel module therein in an absence of the modular biometric reader.

21. A electronic device, comprising:
a housing having a module bay open to a working surface of the electronic device and configured to receive insertion of a modular unit therein, the modular unit comprising at least one of a speaker, a voice transceiver, a wireless earphone, a biometric reader and a pointing device.

22. The electronic device of claim 21, wherein the modular unit is located and usable within a periphery of the housing when disposed in the module bay.

23. The electronic device of claim 21, wherein the modular unit is usable while disposed outside the module bay.

24. The electronic device of claim 21, wherein the module bay opens to at least two walls of the housing.

25. The electronic device of claim 21, wherein the modular unit is insertable into the module bay from at least two different directions.
